(19) United States
(12) Patent Application Publication
(10) Pub. No.: US 2026/0160849 A1
(43) Pub. Date: Jun. 11, 2026

(54) METHOD FOR POSITION ESTIMATION VIA COMBINATORIAL CHOICE OF ANTENNA ELEMENTS

(71) Applicant: ZaiNar, Inc., Redwood City, CA (US)

(72) Inventors: Babak Azimi-Sadjadi, Redwood City, CA (US); Raquel Guerreiro Machado, Redwood City, CA (US); David Burgess, Redwood City, CA (US); Philip A. Kratz, Redwood City, CA (US)

(21) Appl. No.: 19/465,338

(22) Filed: Jan. 30, 2026

Related U.S. Application Data
(63) Continuation-in-part of application No. 19/249,114, filed on Jun. 25, 2025.
(60) Provisional application No. 63/663,879, filed on Jun. 25, 2024.
(60) Provisional application No. 63/758,079, filed on Feb. 13, 2025.
(60) Provisional application No. 63/965,959, filed on Jan. 22, 2026.

(51) Int. Cl. G01S 5/02

(52) U.S. Cl. CPC G01S 5/02216; G01S 5/0244

(57) ABSTRACT

A method includes: accessing propagation delay values associated with a signal transmitted from a target device and received at antenna elements of a set of nodes; defining combinations of antenna elements, each combination of antenna elements including an antenna element of each node in the set of nodes. For each combination of antenna elements, the method includes: accessing a group of propagation delay values corresponding to antenna elements in the combination of antenna elements; calculating a candidate position, in a set of candidate positions, occupied by the target device based on the group of propagation delay values. The method includes: isolating a subset of candidate positions, in the set of candidate positions, falling within a selected region in the reference coordinate system; and calculating an estimated position, in the reference coordinate system, occupied by the target device based on a combination of the subset of candidate positions.

### CROSS-REFERENCE TO RELATED APPLICATIONS

This Application is a continuation-in-part of U.S. patent application Ser. No. 19/249,114, filed on 25 Jun. 2025, which claims the benefit of U.S. Provisional Application No. 63/663,879, filed on 25 Jun. 2024, each of which is incorporated in its entirety by this reference.

This application claims the benefit of U.S. Provisional Application No. 63/965,959, filed on 22 Jan. 2026, and U.S. Provisional Application No. 63/758,079, filed on 13 Feb. 2025, each of which is incorporated in its entirety by this reference.

### TECHNICAL FIELD

This invention relates generally to the field of network-based positioning and, more specifically, to a new and useful method for position estimation via combinatorial choice of antenna elements within the field of network-based positioning.

### BRIEF DESCRIPTION OF THE FIGURES

FIG. 1 is a flowchart representation of a method;

FIG. 2 is a flowchart representation of one variation of the method;

FIGS. 3A and 3B are flowchart representations of one variation of the method; and

FIGS. 4A and 4B are flowchart representations of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Methods

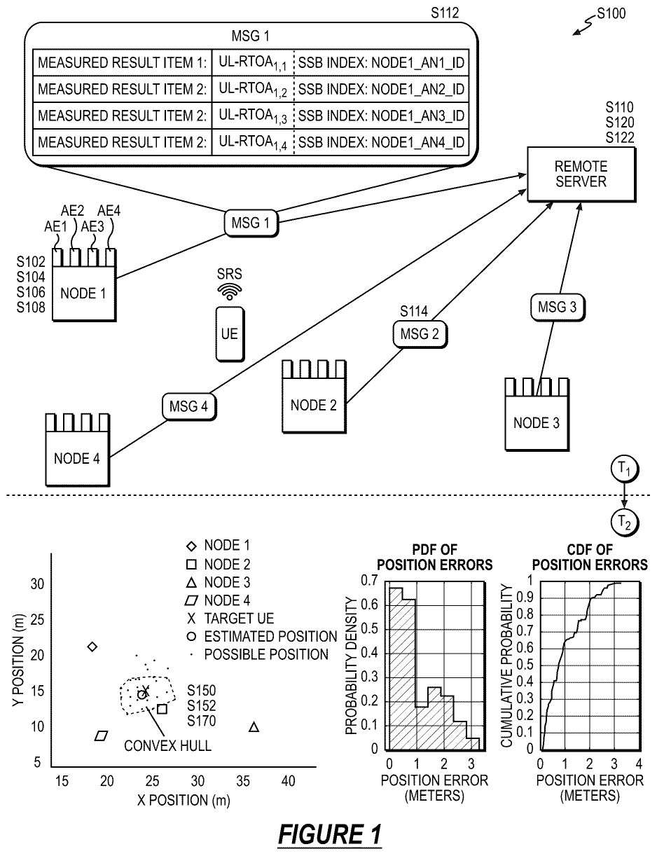

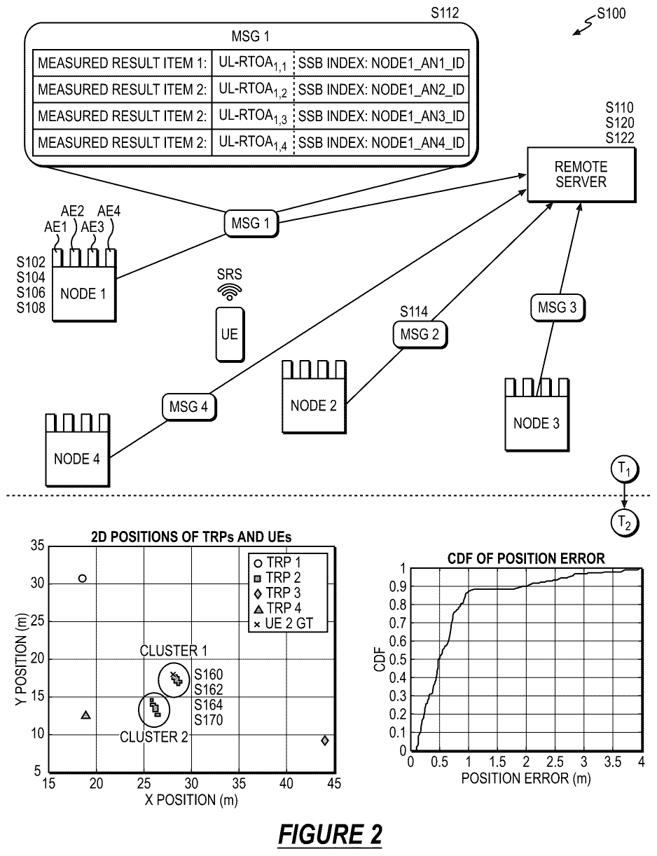

As shown in FIGS. 1 and 2, a method S100 includes: accessing a first set of propagation delay values associated with a signal transmitted from a target device and received at a first node in a set of nodes in Block S112; accessing a second set of propagation delay values associated with the signal received at a second node in the set of nodes in Block S114; and defining a set of combinations of antenna elements in Block S120. Each propagation delay value, in the first set of propagation delay values, corresponds to an antenna element in a first set of antenna elements of the first node. Each propagation delay value, in the second set of propagation delay values, corresponds to an antenna element in a second set of antenna elements of the second node. Each combination of antenna elements includes an antenna element of each node in the set of nodes.

The method S100 also includes, for each combination of antenna elements in the set of combinations of antenna elements: accessing a group of propagation delay values associated with the signal and corresponding to antenna elements in the combination of antenna elements in Block S122; and calculating a candidate position, in a set of candidate positions in a reference coordinate system, occupied by the target device based on the group of propagation delay values in Block S150.

The method S100 further includes: isolating a subset of candidate positions, in the set of candidate positions, falling within a selected region in the reference coordinate system in Block S152; and calculating an estimated position, in the reference coordinate system, occupied by the target device based on a combination of the subset of candidate positions in Block S170.

### 1.1 Variation: Candidate Location Selection Based on Convex Hull

As shown in FIG. 1, one variation of the method S100 includes, at each node in a set of nodes: receiving a signal, transmitted from a target device, at a set of antenna elements of the node in Block S102; calculating a set of time-of-arrival estimates of the signal received at the set of antenna elements in Block S104; generating a message, in a set of messages indicating time-of-arrival estimates of the signal received at nodes in the set of nodes, including the set of time-of-arrival estimates in Block S106; and transmitting the message to a remote computer system in Block S108.

This variation of the method S100 also includes, at the remote computer system: accessing the set of messages from the set of nodes in Block S110; and defining a set of combinations of antenna elements, each combination of antenna elements including an antenna element of each node in the set of nodes in Block S120.

This variation of the method S100 further includes, for each combination of antenna elements in the set of combinations of antenna elements: accessing a group of time-of-arrival estimates of the signal and corresponding to antenna elements in the combination of antenna elements in Block S122; and calculating a candidate position, in a set of candidate positions in a reference coordinate system, occupied by the target device based on the group of time-of-arrival estimates in Block S150.

This variation of the method S100 also includes: isolating a subset of candidate positions, in the set of candidate positions, falling within a convex hull bounded by positions, in the reference coordinate system, occupied by nodes in the set of nodes in Block S152; and calculating an estimated position, in the reference coordinate system, occupied by the target device based on a centroid of candidate positions in the subset of candidate positions in Block S170.

### 1.2 Variation: Candidate Location Selection Based on Clustering

As shown in FIG. 2, one variation of the method S100 includes: for each node in a set of nodes, accessing a set of time-of-arrival estimates of a signal transmitted from a target device and received at the node in Block S110; and defining a set of combinations of antenna elements in Block S120. Each time-of-arrival estimate, in the set of time-of-arrival estimates, corresponds to an antenna element in a set of antenna elements of the node. Each combination of antenna elements includes an antenna element of each node in the set of nodes.

This variation of the method S100 also includes, for each combination of antenna elements in the set of combinations of antenna elements: accessing a group of time-of-arrival estimates of the signal and corresponding to antenna elements in the combination of antenna elements in Block S122; and calculating a candidate position, in a set of candidate positions in a reference coordinate system, occupied by the target device based on the group of time-of-arrival estimates in Block S150.

This variation of the method S100 further includes: grouping candidate positions, in the set of candidate positions, into a set of candidate groups based on proximity of candidate positions in the set of candidate positions in Block S160; for each position group in the set of positions groups, calculating a quantity of candidate positions in the position group in Block S162; selecting a target position group, in the set of position groups, characterized by a greatest quantity of candidate positions among the set of position groups in Block S164; and calculating an estimated position, in the reference coordinate system, occupied by the target device based on a centroid of candidate positions in the target position group in Block S170.

### 2. Applications

Generally, a system—including or interfacing with a target device (e.g., a user equipment, a mobile phone, a tablet, a laptop), a set of nodes (e.g., base stations, 5G gNodeBs, 5G transmission and reception points (or “TRPs”), 5G radio units (or “RUs”)), and a remote computer system (e.g., a remote server, a location management function)—can execute Blocks of the method S100: to transmit a signal (e.g., a sounding reference signal) from the target device; to receive the signal at multiple antenna elements of each node in the set of nodes; to derive time-of-arrival estimates and quality characteristics (e.g., signal-to-noise ratios, quantities of multipath components) for the signal received at these antenna elements; to define combinations of antenna elements representing the set of nodes, each combination of antenna elements including one antenna element from each node in the set of nodes; for each combination of antenna elements, to calculate a possible position of the target device in a space (e.g., a two-dimensional space, a three-dimensional space) based on time-of-arrival estimates and/or quality characteristics of the signal received at antenna elements in the combination of antenna elements; to calculate a convex hull-representing an area of interest in the space-based on the set of nodes and/or the set of possible positions; to isolate a subset of possible positions, in the set of possible positions, that fall within the convex hull; and to calculate an estimated position of the target device in the space based on a combination (e.g., a centroid, an average) of the subset of possible positions.

Accordingly—by deriving timing-based measurements of the signal received at antenna elements independently of phase coherence, phase alignment, and/or phased-array calibration across these antenna elements—the system can model antenna elements as independent measurement sources for position estimation in order: to define combinations of antenna elements across nodes; and to compute multiple candidate position estimates based on different combinations of antenna-element timing measurements.

Therefore, rather than calculating an estimated position of the target device based on one time-of-arrival estimate of the signal for each node in a set of N nodes (e.g., four nodes), the system can execute Blocks of the method S100: to independently calculate multiple time-of-arrival estimates of the signal at M antenna elements (e.g., four antenna elements) of each node; to calculate MN possible positions (e.g., 256 possible positions) of the target device-such as via maximum likelihood position estimation and/or weighted time-difference-of-arrival position estimation-based on time-of-arrival estimates of the signal for combinations of antenna elements from the set of nodes; and to calculate the estimated position of the target device in the space based on a subset of these possible positions falling within a selected area of interest, thereby increasing measurement diversity (e.g., channel impulse response diversity, time-of-arrival diversity) in order to increase accuracy of position estimation and/or reduce an impact of multipath-induced error.

### 2.1 Measurement Messages

More specifically, the system can execute Blocks of the method S100: to receive the signal at multiple antenna elements of a node; to calculate a time-of-arrival estimate of the signal for each antenna element of the node; to generate a message (e.g., a measurement report message, a measurement result message) specifying these time-of-arrival estimates in (e.g., explicit, implicit) association with these antenna elements; and to transmit this message from the node to the remote computer system.

In one example, for each antenna element of the node, the system can execute Blocks of the method S100: to generate a measured result item (e.g., an uplink relative time of arrival (or “UL-RTOA”) measurement information element (or “IE”)) specifying a time-of-arrival estimate of the signal received at the antenna element; and to encode an antenna element identifier (e.g., an antenna element index) into a measurement beam information element of the measured result item, such as in a synchronization signal block (or “SSB”) index field of the measurement beam information element.

In this example, the system can execute Blocks of the method S100 to generate the message, including a set of measured result items representing: the time-of-arrival estimates of the signal for antenna elements of the node; and antenna element identifiers for these antenna elements.

In another example, rather than explicitly encode antenna element identifiers into the message, the system can execute Blocks of the method S100 to implicitly associate each measured result item with a corresponding antenna element based on a position of the measured result item in a predefined sequence-according to the antenna element identifiers (e.g., the antenna element indices) of the set of antenna elements—in the message.

Therefore, the system can execute Blocks of the method S100 to implement a messaging protocol that reports multiple time-of-arrival estimates—associated with specific antenna elements of a node—from the node to the remote computer system in accordance with telecommunications protocol definitions (e.g., 3GPP New Radio Positioning Protocol A (NRPPA)), thereby enabling incoherent multi-antenna positioning techniques across a variety of network architectures without requiring phase-coherent processing, phased-array calibration, or control over deployed antenna hardware.

In particular—by implementing these timing-based, phase-agnostic positioning techniques—the system can avoid limitations associated with phased-array and angle-of-arrival (or “AoA”) estimation techniques that may rely on precise phase relationships across antenna elements and/or may require accurate knowledge of antenna geometry, phase calibration, and compensation for effects such as mutual coupling between antenna elements, which may be difficult or impractical to satisfy in deployed wireless networks such as in carrier-standard base station antenna arrays where antenna calibration, internal array geometry, and element-level phase information are fixed, proprietary, or inaccessible to a positioning system.

### 2.2 Variation: Combinatorial Choice of Antenna Elements+Clustering

In one variation, the system can execute Blocks of the method S100: to transmit a signal from the target device; to receive the signal at multiple antenna elements of each node in the set of nodes; to calculate a time-of-arrival estimate of the signal for each antenna element of these nodes; to define combinations of antenna elements representing the set of nodes; for each combination of antenna elements, to calculate a possible position of the target device in a space (e.g., a two-dimensional space, a three-dimensional space) based on time-of-arrival estimates of the signal at antenna elements in the combination of antenna elements; to detect clusters of possible positions, such as based on k-means clustering techniques; to select a target cluster of possible positions including the greatest quantity of possible positions; and to calculate an estimated position occupied by the target device based on these possible positions in the target cluster.

Therefore, rather than calculating the estimated position based on an average of all possible positions, the system can execute Blocks of the method S100: to detect clusters of possible positions of the target device; to isolate a target cluster including the greatest quantity of possible positions (and/or characterized by the greatest confidence value); and to calculate the estimated position of the target device based on possible positions in the target cluster, thereby improving accuracy and/or reducing error of position estimation for the target device, such as when multiple antenna elements in a node detect different channel impulse responses that yield different time-of-arrival estimates for the node.

2.3 Variation: Timing Measurements from Independent Signal Resources

As described herein, the system executes the method S100: to transmit a signal from a target device; to receive the signal at multiple antenna elements of each node in a set of nodes; to derive time-of-arrival estimates for the signal received at these antenna elements; to define combinations of antenna elements representing the set of nodes, each combination of antenna elements including one antenna element from each node in the set of nodes; for each combination of antenna elements, to calculate a possible position—in a set of possible positions—of the target device based on time-of-arrival estimates of the signal received at antenna elements in the combination of antenna elements; and to calculate an estimated position of the target device in the space based on the set of possible positions.

However, the system can similarly execute Blocks of the method S100: to derive timing measurements (e.g., time-of-arrival estimates) from different signal resources associated with each node in the set of nodes, such as different time slots, frequency resources, resource blocks, sounding reference signal combs, or uplink MIMO ports, etc.; and to process these timing measurements derived from these signal resources as independent timing measurement sources in combinatorial position estimation.

For example, the system can execute Blocks of the method S100: to receive a sounding reference signal transmitted by a target device implementing a set of (e.g., multiple) transmit ports; to isolate signal observations corresponding to different propagation channels formed between the set of transmit ports of the target device and antenna elements of each node; and to calculate distinct time-of-arrival estimates for each propagation channel based on sounding reference signals transmitted on different ports or interleaved signal resources.

In this example, the system can then execute Blocks of the method S100: to access the distinct time-of-arrival estimates corresponding to the propagation channels; to define combinations of propagation channels representing the set of nodes, each combination of antenna elements including one propagation channel from each node in the set of nodes; for each combination of propagation channels, to calculate a possible position—in a set of possible positions—of the target device based on time-of-arrival estimates corresponding to propagation channels in the combination of propagation channels; and to calculate an estimated position of the target device in the space based on the set of possible positions.

Therefore, rather than constraining combinatorial position estimation to timing measurements derived from distinct physical antenna elements, the system can execute Blocks of the method S100 to leverage timing measurements derived from multiple independent signal resources and/or propagation channels associated with each node. By processing timing measurements obtained from different time, frequency, spatial, and/or port-based signal resources as independent inputs to combinatorial position estimation, the system can increase diversity (and quantity) of timing measurements available for position estimation without requiring additional antenna hardware, phase-coherent processing, or control over deployed antenna arrays, thereby improving positioning accuracy and robustness in environments where antenna elements are closely spaced and/or partially co-located.

### 3. System

Generally, as shown in FIGS. 1 and 2, the system can include and/or interface with: a set of nodes (e.g., base stations, 5G gNodeBs, 5G radio units, 5G transmission and reception points); and a set of devices (e.g., 5G user equipment, a mobile phone, a cellular modem, a laptop computer including a wireless network interface device). Additionally, the system can include and/or interface with a remote computer system (e.g., a remote server, a location management function).

In one implementation, the system includes a set of nodes (or “receivers”) arranged in a space. A node includes an antenna array including a set of antenna elements (e.g., four antenna elements, eight antenna elements).

In one example, the set of nodes can include a first gNodeB and a first transmission and reception point in a subset of transmission and reception points. The first includes a set of geographically co-located antennas (e.g., an antenna array(s) including a set of antenna elements with (or without) distinct polarization, multiple input multiple output (MIMO) arrays, beamforming arrays) that support transmission point and/or reception point functionality. Additionally, the first transmission and reception point can include a remote radio head.

In this example, the first gNodeB serves the subset of transmission and reception points, including the first transmission and reception point.

Each node, in the set of nodes, occupies a known position in a reference coordinate system (e.g., a two-dimensional coordinate system, a three-dimensional coordinate system) representing the space. For example, the set of nodes can be uniformly distributed in space.

In this implementation, the system includes a target device (or “transmitter”) occupying a target (unknown) position in the reference coordinate system.

In another implementation, the system transmits (e.g., broadcasts) a signal (e.g., a ranging signal, a localization signal, a sounding reference signal) from the target device. For example, the target device can transmit the signal in response to a request (e.g., from a client system) for an estimated position of the target device.

In another implementation, a first node in the set of nodes: receives the signal at a first antenna element in a first set of antenna elements of the first node; and calculates a first time-of-arrival estimate—in a first set of time-of-arrival estimates—of the signal received at the first antenna element.

The first node repeats the foregoing methods and techniques for each antenna element in the first set of antenna elements: to receive the signal at the antenna element; and to calculate a time-of-arrival estimate—in the first set of time-of-arrival estimates—of the signal received at the antenna element.

In third implementation, the first node: generates a first message specifying the first set of time-of-arrival estimates of the signal received at the first node; and transmits the first message to the remote computer system.

The system repeats the foregoing methods and techniques for each node in the set of nodes: to receive the signal at a set of antenna elements of the node; to calculate a set of times-of-arrival estimates of the signal received at the set of antenna elements; to generate a message specifying the set of time-of-arrival estimates of the signal received at the node; and to transmit the message to the remote computer system.

In another implementation, the system (e.g., the remote computer system): receives the set of messages from the set of nodes; and calculates an estimated position, in the reference coordinate system, occupied by the target device based on the set of time-of-arrival estimates in the set of messages, such as via maximum likelihood position estimation and/or weighted time-difference-of-arrival position estimation.

More specifically, the remote computer system can define a set of combinations of antenna elements. Each combination of antenna elements can include an antenna element of each node in the set of nodes.

For each combination of antenna elements in the set of combinations of antenna elements, the remote computer system can: access a group of time-of-arrival estimates-specified in the set of messages—of the signal received at antenna elements in the combination of antenna elements; and calculate a candidate position, in a set of candidate positions in the reference coordinate system, occupied by the target device based on the group of time-of-arrival estimates. The remote computer system can then calculate an estimated position, in the reference coordinate system, occupied by the target device based on a combination of the set of candidate positions.

In one example, the remote computer system calculates the estimated position based on an average of the set of candidate positions.

In another example, the remote computer system: calculates a convex hull bounced by positions occupied by the set of nodes; isolates a subset of candidate positions, in the set of candidate positions, that falls within the convex hull; and calculates the estimated position occupied by the target device based on a combination (e.g., an average) of the subset of candidate positions.

In another example, the remote computer system: groups candidate positions, in the set of positions, into a set of candidate groups (e.g., based on proximity of candidate positions in the set of candidate positions); selects a target position group, in the set of position groups, characterized by a greatest quantity of candidate positions among the set of position groups; and calculates the estimated position occupied by the target device based on candidate positions in the target position group (e.g., corresponding to a centroid of candidate positions in the target position group).

In this implementation, the system returns the estimated position occupied by the target device (e.g., to the client system) responsive to the request.

Accordingly, the remote computer system can calculate a time-of-arrival estimate of a signal transmitted by a target device and received at each antenna element of each node in a set of nodes; define combinations of antenna elements—each combination of antenna elements including one antenna element of each node in the set of nodes-representing the set of nodes; calculate possible positions of the target device for these combinations of antenna elements based on time-of-arrival estimates of the signal received at antenna elements in each combination of antenna elements; and estimate a position occupied by the target device according to these possible positions.

Therefore, the system can increase measurement (e.g., channel impulse response, time of arrival) diversity in order to increase accuracy of position estimation and/or reduce an impact of multipath-induced error.

### 4. Reference Signal

The method S100 includes, at each node in a set of nodes: receiving a signal, transmitted from a target device, at a set of antenna elements of the node in Block S102; and calculating a set of time-of-arrival estimates of the signal received at the set of antenna elements in Block S104.

Generally, in Blocks S102 and S104, the system can: instruct a node (e.g., a serving node) to schedule the target device to transmit a signal (e.g., a sounding reference signal, a localization signal); select a set of configuration parameters for the signal; and instruct a set of nodes (e.g., the serving node, a subset of measuring nodes) to measure the signal according to the set of configuration parameters.

In one implementation, the system receives a request for an estimated position—in the reference coordinate system-occupied by the target device, such as from a client system (e.g., a client device, a client application).

In response to receiving the request, the system: selects a set of nodes (e.g., a node that serves the target device, a node proximal the target device); selects a set of configuration parameters (e.g., a bandwidth, a subcarrier spacing value, a set of antenna ports, a transmit power, a frequency position) for the signal; instructs (or schedules) the target device to transmit the signal according to the set of configuration parameters; and instructs the set of nodes to capture and record measurements of the signal according to the set of configuration parameters and/or a transaction identifier.

For example, the system can select the set of nodes including: a first node that serves the target device; a second node proximal the target device; a third node proximal the target device; and a fourth node proximal the target device.

In this example: the first node includes a first set of antenna elements (e.g., four antenna elements); the second node includes a second set of antenna elements; the third node includes a third set of antenna elements; and the fourth node includes a fourth set of antenna elements.

In another implementation, the target device transmits (e.g., broadcasts) the signal according to the set of configuration parameters.

In this implementation, a node: receives the signal at a set of antenna elements of the node in Block S102; and calculates a set of time-of-arrival estimates of the signal received at the set of antenna elements in Block S104.

More specifically, the node can: detect the signal exhibiting a set of characteristics corresponding to the set of configuration parameters; and record a time-of-arrival estimate of the signal in association with the transaction identifier.

Therefore, by detecting the signal exhibiting the set of characteristics corresponding to the set of configuration parameters, the node can (implicitly) identify the signal based on the set of characteristics rather than based on a unique identifier associated with (or embedded within) the signal.

### 4.1 Times of Arrival of Signal at First Node

In one implementation, a first node in the set of nodes: receives the signal at a first antenna element in the first set of antenna elements; calculates a first time-of-arrival estimate—in a first set of time-of-arrival estimates—of the signal received at the first antenna element in Block S104; and records the first time-of-arrival estimate in association with a first antenna element identifier (e.g., an antenna element index), in a first set of antenna element identifiers, of the first antenna element.

In this implementation, the system: calculates a first set of quality characteristics of the signal received at the first antenna element; and records the first set of quality characteristics in association with the first antenna element identifier. The first set of quality characteristics includes: a first signal-to-noise ratio of the signal received at the first antenna element; and/or a first quantity of components (e.g., multipath components) of the signal received at the first antenna element; etc.

Additionally or alternatively, the first node can: characterize a first channel impulse response of the signal received at the first antenna element; and record the first channel impulse, in a first set of channel impulse responses, in association with the first antenna element identifier. The first channel impulse response is characterized by a first set of amplitude values- and a first set of propagation delay values—that correspond to the set of components of the signal.

In one variation, the first node: calculates a first subset of (e.g., multiple) time-of-arrival estimates—in the first set of times of arrival—of the signal received at the first antenna element; and records the first subset time-of-arrival estimates in association with the first antenna element identifier.

The first node repeats the foregoing methods and techniques for each antenna element in the first set of antenna elements: to receive the signal at the antenna element; to characterize a channel impulse response, in the first set of channel impulse responses, of the signal; to calculate a time-of-arrival estimate(s)—in the first set of time-of-arrival estimates—of the signal received at the antenna element; to calculate a set of quality characteristics of signal received at the antenna element; and to record the time-of-arrival estimate, the set of quality characteristics, and/or the channel impulse response in association with an antenna element identifier, in the first set of antenna element identifiers, of the antenna element.

### 4.2 Times of Arrival of Signal at Additional Nodes

The system repeats the foregoing methods and techniques for each node in the set of nodes: to receive the signal at a set of antenna elements of the node; to calculate a set of time-of-arrival estimates of the signal received at the set of antenna elements; to calculate sets of quality characteristics of the signal received at the set of antenna elements; to characterize a set of channel impulse responses that correspond to a set of components of the signal received at the set of antenna elements; and to record the set of time-of-arrival estimates, the sets of quality characteristics, and/or the set of channel impulse responses in association with a set of antenna element identifiers of the set of antenna elements.

### 5. Measurement Message

The method S100 includes: generating a message, in a set of messages indicating time-of-arrival estimates of the signal received at nodes in the set of nodes, including the set of time-of-arrival estimates in Block S106; and transmitting the message to a remote computer system in Block S108.

Generally, in Blocks S106 and S108, for each node in the set of nodes, the system can: access a set of time-of-arrival estimates of the signal received at a set of antennas of the node; generate a message specifying the set of time-of-arrival estimates; and transmit the message to the remote computer system.

In one implementation, the first node: accesses the first set of time-of-arrival estimates of the signal received at the first set of antenna elements of the first node; accesses sets of quality characteristics (e.g., signal-to-noise ratios, quantities of components) of the signal received at the first set of antenna elements; generates a first message (e.g., a measurement report message, a measurement response message) specifying the first set of time-of-arrival estimates—and the sets of quality characteristics—associated with the first set of antenna elements in Block S106; and transmits the first message to the remote computer system in Block S108.

For example, the first node can access: the first time-of-arrival estimate of the signal received at the first antenna element in the first set of antenna elements and associated with the first antenna element identifier; a second time-of-arrival estimate of the signal received at a second antenna element in the first set of antenna elements and associated with a second antenna element identifier; a third time-of-arrival estimate of the signal received at a third antenna element in the first set of antenna elements and associated with a third antenna element identifier; and a fourth time-of-arrival estimate of the signal received at a fourth antenna element in the first set of antenna elements and associated with a fourth antenna element identifier.

In this example, the first node can generate the first message specifying: the first time-of-arrival estimate; the second time-of-arrival estimate; the third time-of-arrival estimate; the fourth time-of-arrival estimate; the first antenna element identifier associated with the first time-of-arrival estimate; the second antenna element identifier associated with the second time-of-arrival estimate; the third antenna element identifier associated with the third time-of-arrival estimate; and the fourth antenna element identifier associated with the fourth time-of-arrival estimate.

More specifically, the first node can generate a first measured result item (e.g., an uplink relative time-of-arrival (UL-RTOA) measurement information element (or “IE”))—in a first set of measured result items in the first message—representing: a first identifier of the first node; a first timestamp of the signal; and the first time-of-arrival estimate of the signal received at the first antenna element (e.g., based on a dominant path, based on an alternative path). The system can also generate the first measured result item representing a first set of quality characteristics of the signal received at the first antenna element, such as: a first signal-to-noise ratio of the signal received at the first antenna element; and/or a first quantity of components of the signal received at the first antenna element; etc.

Additionally, the first node can encode the first antenna element identifier in a first measurement beam information element of the first measured result item. For example, the first node can encode the first antenna element identifier in a first synchronization signal block (or “SSB”) index field of the first measurement beam information element.

Additionally or alternatively, the first node can: access a first set of channel impulse responses (e.g., propagation delay values, amplitude values) corresponding to the signal received at the first set of antenna elements of the first node; generate the first message specifying the first set of channel impulse responses and the first set of antenna element identifiers associated with the first set of antenna elements; and transmit the first message to the remote computer system.

For example, for the first antenna element in the first set of antenna elements of the first node, the first node can access a first channel impulse response in the first set of channel impulse responses. The first channel impulse response represents: a first propagation value (or a first candidate time-of-arrival estimate) corresponding to a first candidate line-of-sight component of the signal; a second propagation value (or a second candidate time-of-arrival estimate) corresponding to a second candidate line-of-sight component of the signal; and a third propagation value (or a third candidate time-of-arrival estimate) corresponding to a third candidate line-of-sight component of the signal.

In this example, the first node can generate the first message specifying the first propagation value, the second propagation value, and the third propagation value associated with the first antenna element.

The first node can repeat the foregoing methods and techniques for each antenna element in the first set of antenna elements: to generate a measured result item—in the first set of measured result items—representing the first identifier of the first node, the timestamp of the signal, a time-of-arrival estimate (e.g., the second time-of-arrival estimate, the third time-of-arrival estimate, the fourth time-of-arrival estimate) and/or quality characteristics (e.g., a signal-to-noise ratio, a quantity of components) of the signal received at the antenna element (e.g., based on a dominant path, based on an alternative path) (and/or a channel impulse response of the signal received at the antenna element); and to encode an antenna element identifier associated with the time of arrival in a measurement beam information element of the measured result item.

The first node can then: generate the first message including the first set of measured result items—representing the first set of time-of-arrival estimates—such as in a measurement result list; and transmit the first message to the remote computer system.

Accordingly, the first node can: independently calculate a time-of-arrival estimate of the signal for each antenna element of the first node; generate the first message specifying these time-of-arrival estimates and encoded with antenna element identifiers associated with the time-of-arrival estimates; and transmit the message to the remote computer system for position estimation.

Therefore, the system can report multiple time-of-arrival estimates-associated with specific antenna elements of the first node—from the first node to the remote computer system in accordance with telecommunications protocol definitions (e.g., 3GPP New Radio Positioning Protocol A (NRPPA)) in order to enable incoherent multi-antenna positioning techniques across a variety of network architectures.

Each node in the set of nodes repeats the foregoing methods and techniques: to access the set of time-of-arrival estimates, sets of quality characteristics, and/or a set of channel impulse responses of the signal at the set of antenna elements of the node; to generate a message (e.g., a measurement report message, a measurement response message) specifying the set of time-of-arrival estimates, the sets of quality characteristics, the set of channel impulse responses, and/or the set of antenna element identifiers associated with the set of antenna elements; and to transmit the message to the remote computer system.

### 5.1 Implicit Antenna Element Identities

In one variation, the system executes the foregoing methods and techniques: to access a set of time-of-arrival estimates of the signal received at a set of antenna elements of a node; to access sets of quality characteristics (e.g., signal-to-noise ratios, quantities of components) of the signal received at the set of antenna elements; and/or to access sets of channel impulse responses (e.g., propagation delay values, quantities of components) of the signal received at the set of antenna elements.

In this variation, the system generates a message including the set of time-of-arrival estimates arranged in a sequence according to indices of the set of antenna elements of the node.

More specifically, for each antenna element in the set of antenna elements, the system can execute the foregoing methods and techniques: to generate a measured result item—in a set of measured result items—representing the time-of-arrival estimate(s) of the signal received at the antenna element, the set of quality characteristics of the signal received at the antenna element, and/or the channel impulse response of the signal received at the antenna element; and to arrange the measured result item in a position in the sequence within the message according to an index of the antenna element.

For example—for a first antenna element, in the set of antenna elements, characterized by a first index (e.g., an antenna identifier corresponding to the first index)—the system can generate a first measured result item, in the set of measured result items, representing a first time-of-arrival estimate(s) of the signal received at the first antenna element, a first set of quality characteristics of the signal received at the first antenna element, and/or a first channel impulse response of the signal received at the first antenna element; and to arrange the first measured result item in a first position in the sequence within the message according to the first index of the first antenna element.

In this example—for a second antenna element, in the set of antenna elements, characterized by a second index succeeding the first index—the system can generate a second measured result item, in the set of measured result items, representing a second time-of-arrival estimate(s) of the signal received at the second antenna element, a second set of quality characteristics of the signal received at the second antenna element, and/or a second channel impulse response of the signal received at the second antenna element; and to arrange the second measured result item in a second position in the sequence within the message according to the second index of the second antenna element. The second position succeeds the first position.

Accordingly, rather than encoding the set of antenna identifiers in the message, the system can implicitly associate each measured result item with a corresponding antenna element based on the position of the measured result item within the sequence in the message.

Therefore, the system can enable the remote computer system to associate the antenna element corresponding to each time-of-arrival estimate, set of quality characteristics, and/or channel impulse response absent explicit antenna element identifiers in the message, thereby reducing overhead in the message and/or freeing message payload budget for other information, such as additional time-of-arrival estimates, quality characteristics, and/or channel impulse responses, etc.

### 6. Position Estimation Via Combinatorial Choice of Antenna Elements

The method S100 includes, at the remote computer system: accessing the set of messages from the set of nodes in Block S110; and defining a set of combinations of antenna elements in Block S120. Each combination of antenna elements includes an antenna element of each node in the set of nodes.

The method S100 includes, for each combination of antenna elements in the set of combinations of antenna elements: accessing a group of time-of-arrival estimates of the signal and corresponding to antenna elements in the combination of antenna elements in Block S122; and calculating a candidate position, in a set of candidate positions in a reference coordinate system, occupied by the target device based on the group of time-of-arrival estimates in Block S150.

The method S100 includes: isolating a subset of candidate positions, in the set of candidate positions, falling within a selected region in the reference coordinate system in Block S152; and calculating an estimated position, in the reference coordinate system, occupied by the target device based on a combination of the subset of candidate positions in Block S170.

Generally—in Block S110, S120, S122, S150, S152, and S170—the system can: receive a set of messages, representing time-of-arrival estimates of the signal received at antenna elements of the set of nodes, at the remote computer system; define a set of combinations of antenna elements. Each combination of antenna elements includes an antenna element of each node in the set of nodes.

For each combination of antenna elements in the set of combinations of antenna elements, the system can: access a group of time-of-arrival estimates—specified in the set of messages—of the signal received at antenna elements in the combination of antenna elements; and calculate a candidate position, in a set of candidate positions in the reference coordinate system, occupied by the target device based on the group of time-of-arrival estimates.

The system can then: isolate a subset of candidate positions, in the set of candidate positions, representing an area of interest; and calculate an estimated position, in the reference coordinate system, occupied by the target device based on a combination of the subset of candidate positions.

Therefore, the system can: aggregate incoherent times of arrival of the signal—transmitted by a target device—for multiple antenna elements at each node in the set of nodes; calculate possible positions of the target device for combinations of antenna elements based on times of arrival of the signal at these antenna elements; and estimate a position occupied by the target device according to these possible positions—such as via maximum likelihood position estimation (and/or another position estimation technique according to available computational resources)—in order to increase accuracy of position estimation and/or reduce an impact of multipath-induced error.

### 6.1 Message Reception

Generally—in Blocks S110, S112, and S114—the remote computer system can receive the set of messages representing time-of-arrival estimates, quality characteristics, and/or channel impulse responses of the signal received at antenna elements of the set of nodes.

In one implementation, in Block S112, the system accesses a first message—in the set of messages—including a first set of time-of-arrival estimates, sets of quality characteristics (e.g., signal-to-noise ratios, quantities of components), and/or a first set of channel impulse responses of the signal received at a first set of antenna elements of the first node. Each time-of-arrival estimate, in the first set of time-of-arrival estimates, corresponds to an antenna element in the first set of antenna elements.

For each antenna element in the first set of antenna elements of the first node, the remote computer system receives the first message specifying: a time-of-arrival estimate of the signal received at the antenna element; a set of quality characteristics of the signal received at the antenna element; a channel impulse response of the signal received at the antenna element; and/or an antenna element identifier of the antenna element.

For example, the remote computer system can access a first set of propagation delay values—in the first message—associated with the signal received at the first set of antenna elements. Each propagation delay value, in the first set of propagation delay values, corresponds to an antenna element in the first set of antenna elements. The first set of propagation delay values can include: a first propagation delay value corresponding to a first antenna element in the first set of antenna elements; a second propagation delay value corresponding to a second antenna element in the first set of antenna elements; etc.

Alternatively, rather than accessing the first set of propagation delay values (directly) from the first message, the remote computer system can: access a first set of time-of-arrival estimates from the first message; and derive the first set of propagation delay values based on the first set of time-of-arrival estimates.

In another implementation, in Block S114, the remote computer system executes the foregoing methods and techniques to access a second message—in the set of messages-including a second set of time-of-arrival estimates, sets of quality characteristics, and/or a second set of channel impulse responses of the signal received at a second set of antenna elements of the second node.

For example, the remote computer system can access a second set of propagation delay values—in a second message in the set of messages or derived from a second set of time-of-arrival estimates-associated with the signal received at a second set of antenna elements of a second node in the set of nodes. Each propagation delay value, in the second set of propagation delay values, corresponds to an antenna element in the second set of antenna elements. The second set of propagation delay values can include: a third propagation delay value corresponding to a third antenna element in the second set of antenna elements; a fourth propagation delay value corresponding to a fourth antenna element in the second set of antenna elements; etc.

In another implementation, the remote computer system associates time-of-arrival estimates, quality characteristics, and/or channel impulse responses with (identities of) antenna elements based on antenna element identifiers specified in the set of messages.

In one variation, the remote computer system associates time-of-arrival estimates, quality characteristics, and/or channel impulse responses with (identities of) antenna elements based on positions, within messages in the set of messages, occupied by the time-of-arrival estimates, the quality characteristics, and/or the channel impulse responses.

For example, the remote computer system can access a first message from the first node. The first message includes a first set of propagation delay values arranged in a sequence including: a first propagation delay value arranged in a first position in the sequence; and a second propagation delay value arranged in a second position in the sequence.

In this example, the remote computer system can: associate the first propagation delay value with a first antenna element in the first set of antenna elements based on the first position occupied by the first propagation delay value; and associate the second propagation delay value with a second antenna element in the first set of antenna elements based on the second position occupied by the second propagation delay value.

### 6.2 Combinatorial Choice of Antenna Elements

In one implementation, in Block S120, the remote computer system defines a set of combinations of antenna elements. Each combination of antenna elements includes an antenna element of each node in the set of nodes.

For example, the remote computer system can define a first combination of antenna elements including: a first antenna element of the first node; a fifth antenna element of the second node; a sixth antenna element of the third node; and a seventh antenna element of the fourth node. The first combination of antenna elements excludes a second antenna element of the first node.

In this example, the remote computer system can define a second combination of antenna elements including: the second antenna element of the first node; the fifth antenna element of the second node; the sixth antenna element of the third node; and the seventh antenna element of the fourth node. The second combination of antenna elements excludes the first antenna element of the first node.

Therefore, for a set of N nodes (e.g., four nodes) each including M antenna elements (e.g., four antenna elements), the system can define a set of MN combinations of antenna elements (e.g., 256 combinations of antenna elements). Each combination of antenna elements represents an N-node positioning system.

### 6.3 Candidate Position Estimation

In one implementation, for a first combination of antenna elements in the set of combinations of antenna elements, the remote computer system accesses a first group of time-of-arrival estimates of the signal in Block S122. The first group of time-of-arrival estimates corresponds to antenna elements in the first combination of antenna elements.

In this implementation, in Block S150, the remote computer system calculates a first candidate position, in a set of candidate positions in a reference coordinate system, occupied by the target device based on the first group of time-of-arrival estimates.

In one example, the remote computer system can access the first group of time-of-arrival estimates including: the first time-of-arrival estimate of the signal received at the first antenna element of the first node; a fifth time-of-arrival estimate of the signal received at the fifth antenna element of the second node; a sixth time-of-arrival estimate of the signal received at the sixth antenna element of the third node; and a seventh estimate of the signal received at the seventh antenna element of the fourth node.

In this example, the remote computer system can calculate the first candidate position occupied by the target device based on the first time-of-arrival estimate, the fifth time-of-arrival estimate, the sixth time-of-arrival estimate, and the seventh time-of-arrival estimate, such as via time difference of arrival multilateration.

The remote computer system repeats the foregoing methods and techniques for each combination of antenna elements in the set of combinations of antenna elements: to access a group of time-of-arrival estimates of the signal and corresponding to antenna elements in the combination of antenna elements; and to calculate a candidate position, in the set of candidate positions, occupied by the target device based on the group of time-of-arrival estimates.

Therefore, the system can calculate the set of candidate positions (e.g., 256 candidate positions) occupied by the target device based on time-of-arrival estimates (or time-difference-of-arrival estimates) for the set of combinations of antenna elements (e.g., 256 combinations of antenna elements).

In one variation, for each combination of antenna elements in the set of combinations of antenna elements, the system executes similar methods and techniques described above: to access a group of propagation delay values associated with the signal and corresponding to antenna elements in the combination of antenna elements; and to calculate a candidate position, in the set of candidate positions, occupied by the target device based on the group of propagation delay values.

### 6.3.1 Maximum Likelihood Position Estimation

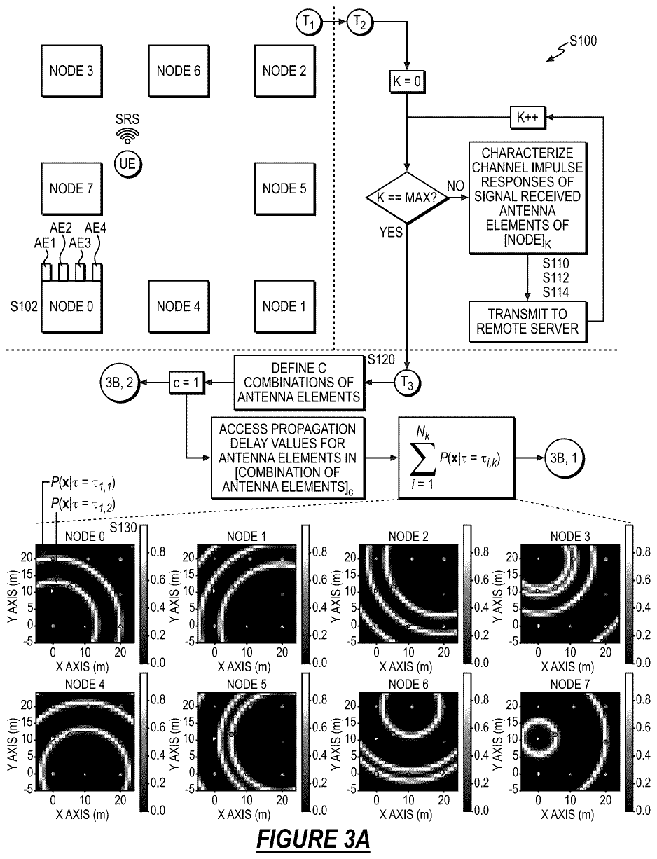

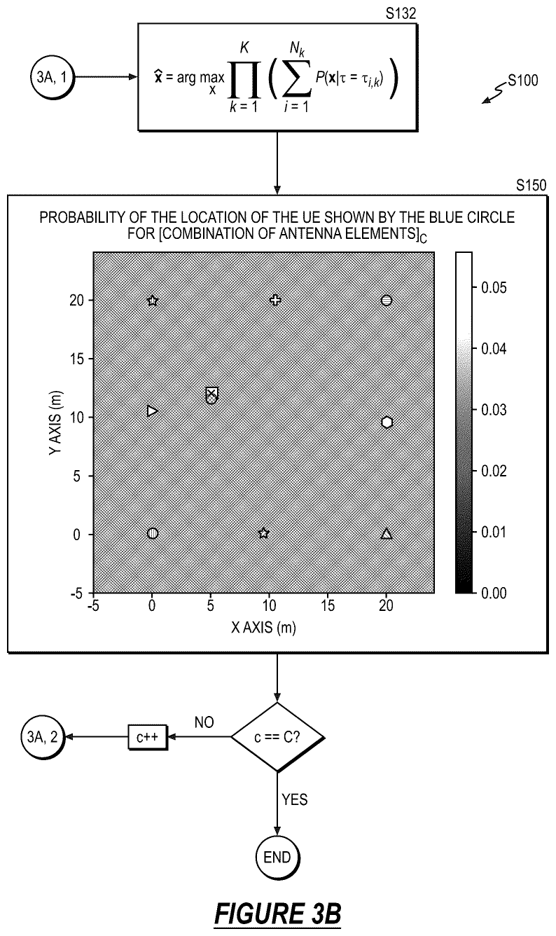

Generally, as shown in FIGS. 3A and 3B, the system can: access a group of channel impulse responses-representing propagation delay values—of the signal received at a combination of antenna elements; calculate probability distributions for positions, in the reference coordinate system, of the target device based on the group of channel impulse responses; and calculate a candidate position, within the reference coordinate system, occupied by the target device based on a combination of the probability distributions (e.g., a joint probability distribution). The candidate position is characterized by the greatest probability mass (or the greatest probability density) (e.g., the greatest likelihood) in the combination of the probability distributions based on the set of propagation delay values.

More specifically, for each antenna element in the combination of antenna elements, the system can access a channel impulse response of the signal received at the antenna element. The channel impulse response is characterized by a subset of propagation delay values—in a set of propagation delay values of a node-corresponding to a set of components (e.g., a line-of-sight component, multipath components) of the signal.

For each propagation delay value in the subset of propagation delay values, the system can calculate a subset of conditional probability masses (or conditional probability densities)—in a set of conditional probability masses (or conditional probability densities)—for the target device occupying positions within the reference coordinate system based on the propagation delay value and a known position, in the reference coordinate system, occupied by the antenna element.

For each antenna element in the combination of antenna elements, the system can generate a probability map (or a probability distribution)—in a set of probability maps and for the antenna element-representing the set of conditional probability masses (or conditional probability densities).

The system can calculate the candidate position, in the reference coordinate system, occupied by the target device based on a combination of the set of probability maps, the candidate position characterized by the greatest probability mass (or the greatest probability density) according to the combination of the set of probability maps.

Therefore, the system can: designate each propagation delay value as a candidate propagation delay value for a line-of-sight component of the signal transmitted from the target device and received at an antenna element in the combination of antenna elements; calculate subsets of conditional probability masses for the target device occupying positions within the reference coordinate system based on the propagation delay values; generate a set of probability maps (e.g., probability distributions) representing subsets of conditional probability masses for the combination of antenna elements; combine conditional probability masses represented in a combination of the set of probability maps (e.g., a joint probability distribution); and derive the candidate position-characterized by the greatest probability mass in the combination of the set of probability maps-occupied by the target device within the reference coordinate system, thereby improving accuracy of position estimation when propagation delay values for line-of-sight components of the signal are unknown (or uncertain).

### 6.3.1.1 Maximum Likelihood Position Estimation: First Probability Map

In one implementation, the remote computer system executes the foregoing methods and techniques to define a first combination of antenna elements, including: a first antenna element of a first node; a second antenna element of a second node; a third antenna element of a third node; and a fourth antenna element of a fourth node.

In another implementation, in Block S122, the remote computer system accesses a first channel impulse response M₁ for the signal received at the first antenna element j₁. In this implementation, the first channel impulse response M₁ is characterized by a first set of amplitude values α_{i,1}—and a first subset of propagation delay values τ_{i,1}—for a first set of components of the signal, wherein:

$${M}_{1} = \{ {α}_{i , 1} , {τ}_{i , 1} \vert i = 1 , 2 , … , {N}_{1} \}$$

For example, the remote computer system can access the first set of propagation delay values absent identification of a target propagation delay value, in the first set of propagation delay values, associated with a line-of-sight component in the first set of components of the signal. In this example, the set of components can include: the line-of-sight component that is deterministic with respect to position; and a set of components that are random with respect to position.

In another implementation, in Block S130, the remote computer system generates a first probability map—in a set of probability maps and representing a first set of conditional probability masses for a set of positions in the reference coordinate system—for the first antenna element j₁. Each position, in the set of positions, is characterized by a set of coordinates in the reference coordinate system. Each conditional probability mass, in the first set of conditional probability masses, represents a probability mass for the target device occupying a position x in the set of positions based on the first subset of propagation delay values.

For example, for a first propagation delay value (e.g., τ_{1,1}) in the first subset of propagation delay values, the remote computer system can calculate a first subset of conditional probability masses P(x|τ=τ_{1,1}), in the first set of conditional probability masses, representing probability masses for the target device occupying positions in the set of positions based on the first propagation delay value and a first position, in the reference coordinate position, occupied by the first antenna element.

In this example, for a second propagation delay value (e.g., τ_{2,1}) in the first subset of propagation delay values, the remote computer system can calculate a second subset of conditional probability masses P(x|τ=τ_{2,1}), in the first set of conditional probability masses, representing probability masses for the target device occupying positions in the set of positions based on the second propagation delay value and the first position occupied by the first antenna element.

The system can repeat the foregoing methods and techniques for each propagation delay value in the first subset of propagation delay values to calculate a subset of conditional probability masses—in the first set of conditional probability masses—representing probability masses for the target device occupying positions in the set of positions based on the propagation delay value and the first position occupied by the first antenna element.

In this example, the remote computer system can generate the first probability map representing a sum of subsets of conditional probability masses-including the first subset of conditional probability masses and the second subset of conditional probability masses—in the first set of conditional probability masses,

$${\sum }_{i = 1}^{{N}_{1}} P ( x \vert τ = {τ}_{i , 1} ) .$$

### 6.3.1.2 Maximum Likelihood Position Estimation: Additional Probability Maps

The remote computer system executes the foregoing methods and techniques for each antenna element in the first combination of antenna elements: to access a channel impulse response—characterized by a subset of propagation delay values in a set of propagation delay values of a node—for the signal received at the antenna element; to calculate a set of conditional probability masses for the set of positions based on the subset of propagation delay values and a known position, in the reference coordinate system, occupied by the antenna element; and to generate a probability map for the antenna element based on the set of propagation delay values. Each conditional probability mass, in the set of conditional probability masses, represents a probability mass for the target device occupying a position in the set of positions based on the subset of propagation delay values.

For example, the remote computer system can access a second channel impulse response M₂—characterized by a second subset of propagation delay values—for the signal received at a second antenna element j₂, wherein:

$${M}_{2} = \{ {α}_{i , 2} , {τ}_{i , 2} \vert i = 1 , 2 , … , {N}_{2} \}$$

In this example, the remote computer system can generate a second probability map—representing a second set of conditional probability masses for the set of positions of the reference coordinate system—for the second antenna element j₂ based on the second subset of propagation delay values. Each conditional probability mass, in the second set of conditional probability masses, represents a probability mass for the target device occupying a position x in the set of positions based on the second subset of propagation delay values.

More specifically, for each propagation delay value in the second set of propagation delay values, the remote computer system can calculate a subset of conditional probability masses P(x|τ=_{i,2})—in the second set of conditional probability masses-representing probability masses for the target device occupying positions in the set of positions based on the propagation delay value and a second position, in the reference coordinate system, occupied by the second antenna element.

The remote computer system can then generate the second probability map representing a sum of subsets of conditional probability masses in the second set of conditional probability masses,

$${\sum }_{i = 1}^{{N}_{2}} P ( x \vert τ = {τ}_{i , 2} ) .$$

### 6.3.1.3 Maximum Likelihood Position Estimation: Candidate Position Estimation

Generally, the remote computer system can characterize a position x, in the reference coordinate system, occupied by the target device based on a probability distribution (e.g., a joint probability distribution) for a first group of channel impulse responses M₁, M₂, . . . , M_{K} for the first combination of antenna elements (e.g., K antenna elements) according to (e.g., given) the position x of the target device, wherein:

$$\hat{x} = arg {max}_{x} P ( {M}_{1} , {M}_{2} , … , {M}_{K} \vert x ) \qquad ( Equation 1 )$$

More specifically, because receiver noise for these antenna elements is independent of each other, the remote computer system can characterize the probability distribution of the first group of channel impulse responses for the first combination of antenna elements given the position x of the target device as:

$$P ( {M}_{1} , {M}_{2} , … , {M}_{K} \vert x ) = {\prod }_{k = 1}^{K} P ( {M}_{k} \vert x )$$

The remote computer system can characterize a particular probability distribution for a particular channel impulse response given the position x of the target device as:

$$P ( {M}_{k} \vert x ) = \frac{P ( x \vert {M}_{k} ) P ( {M}_{k} )}{P ( x )}$$

Additionally, the remote computer system can calculate a probability distribution for the position x according to the particular channel impulse response, wherein:

$$P ( x \vert {M}_{k} ) = {\sum }_{i = 1}^{{N}_{k}} P ( x \vert τ = {τ}_{i , k} ) P ( τ = {τ}_{i , k} ) \qquad ( Equation 2 )$$

$$P ( x \vert {M}_{k} ) = p {\sum }_{i = 1}^{{N}_{k}} P ( x \vert τ = {τ}_{i , k} )$$

More specifically, the remote computer system can define p=P(τ=τ_{i,k}) for discrete random variable t corresponding to a delay grid value in a set of delay grid values.

Accordingly, based on Equation 2, the remote computer system can characterize Equation 1 as:

$$\hat{x} = arg {max}_{x} P ( {M}_{1} , {M}_{2} , … , {M}_{K} \vert x )$$

$$\hat{x} = arg {max}_{x} {\prod }_{k = 1}^{K} P ( {M}_{k} \vert x )$$

$$\hat{x} = arg {max}_{x} C {\prod }_{k = 1}^{K} ( {\sum }_{i = 1}^{{N}_{k}} P ( x \vert τ = {τ}_{i , k} ) )$$

In particular, the remote computer system characterizes Cas a combination of all probabilities (or probability distributions) independent of k. Therefore, the system can calculate the estimated position x occupied by the target device within the reference coordinate system, wherein:

$$\hat{x} = arg {max}_{x} {\prod }_{k = 1}^{K} ( {\sum }_{i = 1}^{{N}_{k}} P ( x \vert τ = {τ}_{i , k} ) )$$

In one implementation, in Block S132, the remote computer system generates a composite probability map based on the set of probability maps. The composite probability map represents a composite set of conditional probability masses—for the set of positions of the reference coordinate system—based on a product of a set of conditional probability masses for each probability map in the set of probability maps.

More specifically, the remote computer system can calculate the composite set of conditional probability masses by multiplying sets of conditional probability masses represented by the set of probability maps, the composite set of conditional probability masses represented as:

$${\prod }_{k = 1}^{K} ( {\sum }_{i = 1}^{{N}_{k}} P ( x \vert τ = {τ}_{i , k} ) )$$

For example, the remote computer system can generate a composite probability map based on the set of probability maps including: the first probability map representing the first set of conditional probability masses; and the second probability map representing the second set of conditional probability masses.

In this example, the remote computer system can generate the composite probability map representing a third set of conditional probability masses based on a product of the first set of conditional probability masses and the second set of conditional probability masses.

In another implementation, in Block S150, the remote computer system calculates the first candidate position \hat{x}—in the set of positions of the reference coordinate system-occupied by the target device based on the composite probability map. The first candidate position \hat{x} is characterized by the greatest probability mass in the composite set of conditional probability masses, wherein:

$$\hat{x} = arg {max}_{x} {\prod }_{k = 1}^{K} ( {\sum }_{i = 1}^{{N}_{k}} P ( x \vert τ = {τ}_{i , k} ) )$$

The remote computer system repeats the foregoing methods and techniques for each combination of antenna elements in the set of combinations of antenna elements: to access a group of channel impulse responses, representing propagation delay values, of the signal received at the combination of antenna elements; to generate a set of probability maps representing sets of conditional probability masses (or conditional probability densities) for the target device occupying positions within the reference coordinate system based on the propagation delay values and known positions, in the reference coordinate system, occupied by the combination of antenna elements; based on the set of probability maps, to generate a composite probability map representing a composite set of conditional probability masses—for the set of positions of the reference coordinate system—based on a product of a set of conditional probability masses for each probability map in the set of probability maps; and to calculate a candidate position, in a set of candidate positions, occupied by the target device based on the composite probability map. The candidate position is characterized by the greatest probability mass in the composite set of conditional probability masses.

### 6.3.2 Weighted Time-Difference-of-Arrival (or “TDOA”) Position Estimation

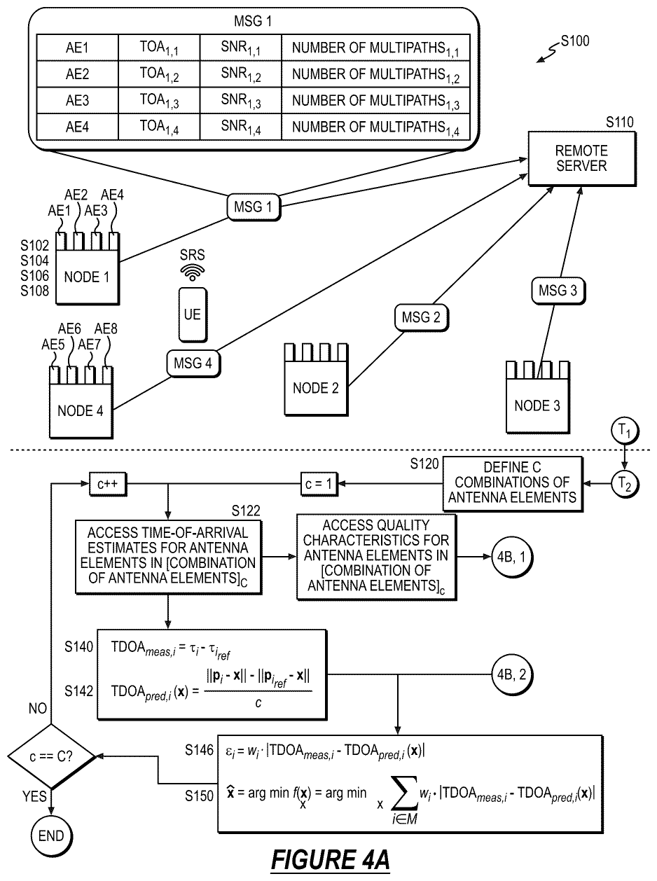

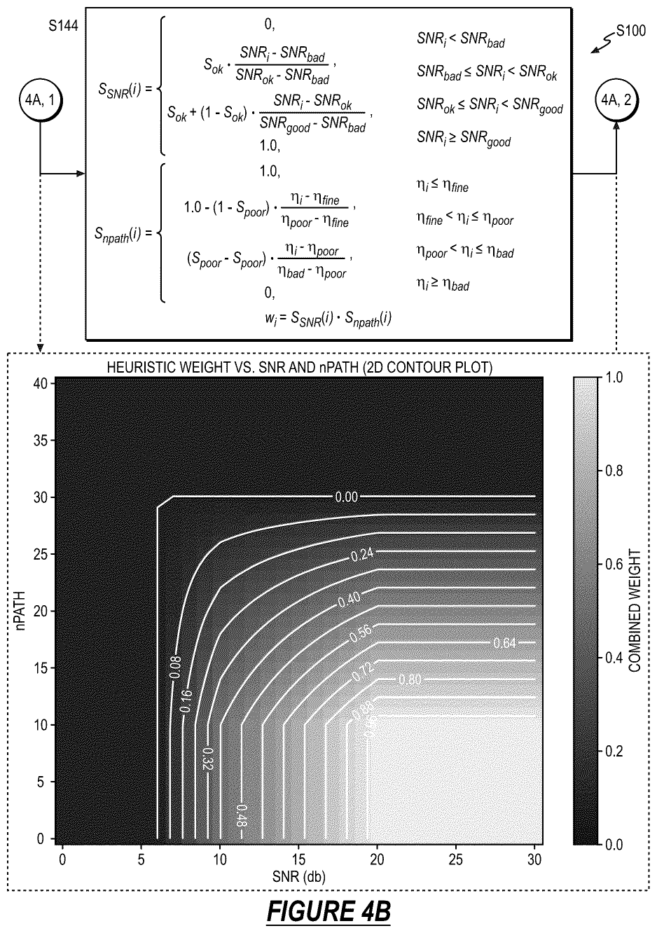

Generally—as shown in FIGS. 4A and 4B, and in Blocks S122, S140, S142, S144, and S146—for each antenna element in a combination of antenna elements, the system can: access a time-of-arrival estimate of the signal received at the antenna element; access a reference time-of-arrival estimate for the signal received at a reference antenna element; calculate a recorded (or “measured”) time-difference-of-arrival estimate based on a difference between the time-of-arrival estimate and the reference time-of-arrival estimate; characterize a predicted time-difference-of-arrival estimate based on positions, in the reference coordinate system, occupied by the antenna element and the reference antenna element; characterize a time-difference-of-arrival error based on a difference between the recorded time-difference-of-arrival estimate and the predicted time-difference-of-arrival estimate; calculate a weight for the time-difference-of-arrival error based on a signal-to-noise ratio of the signal received at the antenna element and a quantity of components of the signal received at the antenna element; and characterize a weighted error metric—in a set of weighted error metrics-based on the time-difference-of-arrival error and the weight.

Accordingly, the system can calculate a candidate position, in the reference coordinate system, occupied by the target device based on a sum of the set of weighted error metrics for the set of antenna elements. More specifically, the system can: access an objective function representing the sum of the set of weighted error metrics; evaluate positions in the reference coordinate system according to the objective function to generate a set of aggregate error values; and select a target position—as the candidate position of the target device—that corresponds to a minimum aggregate error value in the set of aggregate error values according to the objective function.

Therefore, the system can combine physical geometry of the antenna elements and relative quality of each time-of-arrival estimate (according to signal-to-noise ratio and/or quantity of components) in order: to increase accuracy of position estimation; and/or to reduce position error attributed to a degraded (or noisy) signal measurement at an antenna element.

### 6.3.2.1 Weighted TDOA Position Estimation: Time-of-Arrival Estimates+Quality

In one implementation, in Block S120, the remote computer system executes the foregoing methods and techniques to define a first combination of antenna elements including: a first antenna element of a first node; a second antenna element of a second node; a third antenna element of a third node; and a fourth antenna element of a fourth node.

In another implementation, in Block S122, for the first combination of antenna elements, the remote computer system accesses: a first group of time-of-arrival estimates of the first combination of antenna elements; a first group of signal-to-noise ratios of the signal and corresponding to antenna elements in the first combination of antenna elements; and a first group of quantities of components of the signal received at antenna elements in the combination of antenna elements.

In this implementation, the remote computer system: selects an antenna element, in the first combination of antenna elements, as a reference antenna element; and selects a time-of-arrival estimate, in the first group of time-of-arrival estimates, as a reference time-of-arrival estimate.

For example, the remote computer system can access the first group of time-of-arrival estimates including: a first time-of-arrival estimate, in a first set of time-of-arrival estimates of the signal received at the first node, corresponding to the first antenna element; a second time-of-arrival estimate, in a second set of time-of-arrival estimates of the signal received at the second node, corresponding to the second antenna element; a third time-of-arrival estimate, in a third set of time-of-arrival estimates of the signal received at the third node, corresponding to the third antenna element; and a fourth time-of-arrival estimate, in a fourth set of time-of-arrival estimates of the signal received at the fourth node, corresponding to the fourth antenna element.

Additionally, the remote computer system can: access the first group of signal-to-noise ratios including a first signal-to-noise ratio, in the first set of quality characteristics of the signal received at the first node, corresponding to the first antenna element; and access the first group of quantities of components including a first quantity of components, in the first set of quality characteristics of the signal received at the first node, corresponding to the first antenna element.

In this example, the remote computer can: select the fourth antenna element as a reference antenna element; and select the fourth time-of-arrival estimate as a reference time-of-arrival estimate.

### 6.3.2.2 Weighted TDOA Position Estimation: First Weighted Error Metric

In one implementation, the remote computer system executes the foregoing methods and techniques: to access a reference time-of-arrival estimate τi_{ref} of the signal received at the reference antenna element i_{ref}; and to access a first time-of-arrival estimate τ₁ of the signal received at the first antenna element i=1 in the first combination of antenna elements.

In this implementation, in Block S140, the remote computer system calculates a first recorded (or “measured”) time-difference-of-arrival estimate TDOA_{meas,1} based on a difference between the first time-of-arrival estimate 11 and the reference time-of-arrival estimate τi_{ref}, wherein:

$${TDOA}_{meas , 1} = {τ}_{1} - {τ}_{{i}_{r e f}}$$

In another implementation, the remote computer system: accesses a (known) reference position pi_{ref}—in the reference coordinate system-occupied by the reference antenna element i_{ref}; accesses a first (known) position p₁, in the reference coordinate system, occupied by the first antenna element i=1; and characterizes a first predicted time-difference-of-arrival estimate TDOA_{pred,1} based on the reference position pi_{ref} and the first position p₁ in Block S142, wherein:

$${TDOA}_{pred , 1} ( x ) = \frac{‖ {p}_{1} - x ‖ - ‖ {p}_{{i}_{r e f}} - x ‖}{c}$$

In this implementation: x represents a position, in the reference coordinate system, occupied by the target device; and c represents the speed of light. For example, x can represent a position in two dimensions (e.g., x, y) in the reference coordinate system—where a third dimension (e.g., z), in the reference coordinate system, corresponds to a known constant—wherein:

$$x = [ \begin{matrix}x \\ y\end{matrix} ]$$

In another implementation, the system: characterizes a first time-difference-of-arrival error based on a difference between the first recorded time-difference-of-arrival estimate TDOA_{meas,1} and the first predicted time-difference-of-arrival estimate TDOA_{pred,1}(x); calculates a first weight w₁ for the first time-difference-of-arrival error based on a first signal-to-noise ratio of the signal received at the first antenna element and a first quantity of multipath components of the signal received at the first antenna element in Block S144; and characterizes a first weighted error metric ε₁—in a first set of weighted error metrics-based on the first weight and an absolute value of the first time-difference-of-arrival error in Block S148, wherein:

$${ε}_{1} = {w}_{1} \cdot \vert {TDOA}_{meas , 1} - {TDOA}_{pred , 1} ( x ) \vert$$

Accordingly, the system can: calculate the first weight representing a quality of the first time-of-arrival estimate τ₁ for the signal received at the first antenna element according to the first signal-to-noise ratio and the first quantity of components; and to characterize the first weighted error metric ε₁ proportional to the quality in order to prioritize weighted error metrics associated with higher-quality time-of-arrival estimates during position estimation for the target device.

### 6.3.2.3 Weighted TDOA Position Estimation: Additional Weighted Error Metrics

The system repeats the foregoing methods and techniques for each antenna element i in the first combination of antenna elements: to access a time-of-arrival estimate τᵢ for the signal received at the antenna element i; to calculate a recorded time-difference-of-arrival estimate TDOA_{meas,i} based on a difference between the time-of-arrival estimate τᵢ and the reference time-of-arrival estimate τi_{ref}; and to characterize a predicted time-difference-of-arrival estimate TDOA_{pred,i} based on the reference position pi_{ref} and a (known) position pᵢ occupied by the antenna element i, wherein:

$${TDOA}_{meas , i} = {τ}_{i} - {τ}_{{i}_{r e f}}$$

$${TDOA}_{pred , i} ( x ) = \frac{‖ {p}_{i} - x ‖ - ‖ {p}_{{i}_{r e f}} - x ‖}{c}$$

The system then repeats the foregoing methods and techniques for each antenna element i in the set of antenna elements: to characterize a time-difference-of-arrival error based on a difference between the recorded time-difference-of-arrival estimate TDOA_{meas,i} and the predicted time-difference-of-arrival estimate TDOA_{pred,i}(x); to calculate a weight wᵢ for the time-difference-of-arrival error based on a signal-to-noise ratio of the signal received at the antenna element i and a quantity of multipath components of the signal received at the antenna element i; and to characterize a weighted error metric εᵢ—in the first set of weighted error metrics—based on the weight and an absolute value of the time-difference-of-arrival error, wherein:

$${ε}_{i} = {w}_{i} \cdot \vert {TDOA}_{meas , i} - {TDOA}_{pred , i} ( x ) \vert$$

### 6.3.2.4 Weighted TDOA Position Estimation: Heuristic Weight Calculation

In one implementation, the remote computer system: accesses the first signal-to-noise ratio SNR₁ of the signal received at the first antenna element i=1; and calculates a first signal-to-noise ratio score S_{SNR}(1) based on the first signal-to-noise ratio SNR₁.

For example, the remote computer system can calculate the first signal-to-noise ratio score S_{SNR}(1) based on the first signal-to-noise ratio SNR₁ relative to a set of signal-to-noise ratio thresholds including: a first signal-to-noise ratio threshold SNR_{bad} (e.g., six decibels); a second signal-to-noise ratio threshold SNRₒₖ (e.g., ten decibels); and a third signal-to-noise ratio threshold SNR_{good} (e.g., twenty decibels), wherein:

$${S}_{S N R} ( 1 ) = \{ \begin{matrix}0 , & {SNR}_{1} < {SNR}_{bad} \\ {S}_{ok} \cdot \frac{{SNR}_{1} - {SNR}_{bad}}{{SNR}_{ok} - {SNR}_{bad}} , & {SNR}_{bad} \leq {SNR}_{1} < {SNR}_{ok} \\ {S}_{ok} + ( 1 - {S}_{ok} ) \cdot \frac{{SNR}_{1} - {SNR}_{ok}}{{SNR}_{good} - {SNR}_{ok}} , & {SNR}_{ok} \leq {SNR}_{1} < {SNR}_{good} \\ 1. , & {SNR}_{1} \geq {SNR}_{good}\end{matrix}$$

In this example, Sₒₖ represents a first predefined (e.g., intermediate) score (e.g., 0.4) for the second signal-to-noise ratio threshold SNRₒₖ.

In another implementation, the remote computer system accesses the first quantity of components η₁ of the signal received at the first antenna element; and calculates a first multipath component score Sₙₚₐₜₕ(1) based on the first quantity of components η₁.

For example, the remote computer system can calculate the first multipath component score Sₙₚₐₜₕ(1) based on the first quantity of components η₁ relative to a set of multipath component thresholds including: a first multipath component threshold η_{fine} (e.g., ten paths); a second multipath component threshold ηₚₒₒᵣ (e.g., twenty paths); and a third multipath component threshold η_{bad} (e.g., 30 paths), wherein:

$${S}_{npath} ( 1 ) = \{ \begin{matrix}1. , & {η}_{1} \leq {η}_{b a d} \\ 1. - ( 1 - {S}_{poor} ) \cdot \frac{{η}_{1} - {η}_{fine}}{{η}_{poor} - {η}_{fine}} , & {η}_{fine} < {η}_{1} \leq {η}_{poor} \\ {S}_{poor} - {S}_{poor} \cdot \frac{{η}_{1} - {η}_{poor}}{{η}_{bad} - {η}_{poor}} , & {η}_{poor} < {η}_{1} \leq {η}_{bad} \\ 0 , & {η}_{1} \geq {η}_{b a d}\end{matrix}$$

In this example, Sₚₒₒᵣ represents a second predefined (e.g., intermediate) score (e.g., 0.5) according to the second multipath component threshold ηₚₒₒᵣ.

In another implementation, the remote computer system calculates the first weight w₁ based on: the first signal-to-noise ratio score S_{SNR}(1); and the first multipath component score Sₙₚₐₜₕ(1), wherein:

$${w}_{1} = {S}_{S N R} ( 1 ) \cdot {S}_{npath} ( 1 )$$

The remote computer system can repeat the foregoing methods and techniques for each antenna element i in the first combination of antenna elements: to access a signal-to-noise ratio SNRᵢ of the signal received at the antenna element i; to access a quantity of multipath components ηᵢ of the signal received at the antenna element i; to calculate a signal-to-noise ratio score S_{SNR} (i) based on the signal-to-noise ratio SNRᵢ; to calculate a multipath component score Sₙₚₐₜₕ (i) based on the quantity of multipath components ηᵢ; and to calculate a weight wᵢ for a time-difference-of-arrival error based on the signal-to-noise ratio score S_{SNR} (i) and the multipath component score Sₙₚₐₜₕ (i), wherein:

$${S}_{S N R} ( i ) = \{ \begin{matrix}0 , & {SNR}_{i} < {SNR}_{bad} \\ {S}_{ok} \cdot \frac{{SNR}_{i} - {SNR}_{bad}}{{SNR}_{ok} - {SNR}_{bad}} , & {SNR}_{bad} \leq {SNR}_{i} < {SNR}_{ok} \\ {S}_{ok} + ( 1 - {S}_{ok} ) \cdot \frac{{SNR}_{i} - {SNR}_{ok}}{{SNR}_{good} - {SNR}_{ok}} , & {SNR}_{ok} \leq {SNR}_{i} < {SNR}_{good} \\ 1. , & {SNR}_{i} \geq {SNR}_{good}\end{matrix}$$

$${S}_{npath} ( i ) = \{ \begin{matrix}1. , & {η}_{i} \leq {η}_{b a d} \\ 1. - ( 1 - {S}_{poor} ) \cdot \frac{{η}_{i} - {η}_{fine}}{{η}_{poor} - {η}_{fine}} , & {η}_{fine} < {η}_{i} \leq {η}_{poor} \\ {S}_{poor} - {S}_{poor} \cdot \frac{{η}_{i} - {η}_{poor}}{{η}_{bad} - {η}_{poor}} , & {η}_{poor} < {η}_{i} \leq {η}_{bad} \\ 0 , & {η}_{i} \geq {η}_{b a d}\end{matrix}$$

$${w}_{i} = {S}_{SNR} ( i ) \cdot {S}_{npath} ( i )$$

### 6.3.2.5 Weighted TDOA Position Estimation: Candidate Position Estimation

Generally, in Block S150, the remote computer system can: access a target set of weighted error metrics for a target combination of antenna elements; and calculate a candidate position—in a set of candidate positions in the reference coordinate system—occupied by the target device based on a sum of the set of weighted error metrics.

More specifically, the remote computer system can calculate the candidate position that yields a minimum-value sum of the set of weighted error metrics for a set of positions in the reference coordinate system.

In one implementation, the remote computer system accesses an objective function ƒ(x) representing a sum of the first set of weighted error metrics (or a weighted sum of absolute time-difference-of-arrival error metrics) for the first combination of antenna elements M, wherein:

$$f ( x ) = {\sum }_{i ∈ M} {ε}_{i} = {\sum }_{i ∈ M} {w}_{i} \cdot \vert {TDOA}_{meas , i} - {TDOA}_{p r e d , i} ( x ) \vert$$

In this implementation, the remote computer system calculates a first candidate position \hat{x} that yields a minimum-value for the objective function in Block S150, wherein:

$$\hat{x} = arg {min}_{x} f ( x ) = arg {min}_{x} {\sum }_{i ∈ M} {w}_{i} \cdot \vert {TDOA}_{meas , i} - {TDOA}_{pred , i} ( x ) \vert$$

For example, the remote computer system can: access an objective function representing the sum of the first set of weighted error metrics for the first combination of antenna elements; evaluate positions in the reference coordinate system according to the objective function to generate a first set of aggregate error values; and select a target position—as the first candidate position of the target device—that corresponds to a minimum aggregate error value in the set of aggregate error values according to the objective function.

Accordingly, the remote computer system can: access the first set of weighted error metrics for the first combination of antenna elements; and calculate the first candidate position, in the reference coordinate system, occupied by the target device that yields a minimum-value sum of the first set of weighted error metrics.

### 6.3.2.6 Weighted TDOA Position Estimation: Additional Candidate Positions

The remote computer system repeats the foregoing methods and techniques for each combination of antenna elements in the set of combinations of antenna elements: to access a group of time-of-arrival estimates, a group of signal-to-noise ratios, and a group of quantities of components of the signal and corresponding to antenna elements in the combination of antenna elements; to calculate a set of weights for the combination of antenna elements based on the group of signal-to-noise ratios and the group of quantities of components; to calculate a set of recorded time-difference-of-arrival estimates based on the group of time-of-arrival estimates; to characterize a set of predicted time-difference-of-arrival estimates based on positions, in the reference coordinate system, occupied by the combination of antenna elements; to characterize a set of time-difference-of-arrival errors based on the set of recorded time-difference-of-arrival estimates and the set of predicted time-difference-of-arrival estimates; and to calculate a candidate position, in a set of candidate positions in the reference coordinate system, occupied by the target device based on the set of weights and the set of time-difference-of-arrival errors.

More specifically, for each combination of antenna elements in the set of combinations of antenna elements, the remote computer system can execute the foregoing methods and techniques: to characterize a set of weighted error metrics based on the set of weights and (absolute values of) the set of time-difference-of-arrival errors; and to calculate the candidate position that yields a minimum-value sum of the set of weighted error metrics for the set of positions in the reference coordinate system.

### 6.4 Candidate Position Filtering

In one implementation, in Block S152, the remote computer system isolates (or selects) a subset of candidate positions, in the set of candidate positions, falling within a selected region-representing an area of interest—in the reference coordinate system.

For example, the remote computer system can: calculate a convex hull characterized (or bounded) by positions, in the reference coordinate system, occupied by nodes in the set of nodes; and isolate the subset of candidate positions falling within the selected region, including (or characterized by) the convex hull. Each candidate position, in the subset of candidate of positions, falls within the convex hull.

In this example, the remote computer system can isolate the subset of candidate positions: including a first candidate position associated with the first combination of antenna elements; and excluding a second candidate position associated with the second combination of antenna elements.

Therefore, the remote computer system can discard candidate positions, in the set of candidate positions, that are invalid and/or falling outside of the area of interest represented by the convex hull in order to reduce error for position estimation.

In one variation, the remote computer system: accesses (or defines) a set of vertices, in the reference coordinate system, representing an area of interest; calculates a convex hull characterized (or bounded) by the set of vertices; and isolates the subset of candidate positions—in the set of candidate positions-falling within a selected region including (or characterized by) the convex hull.

Therefore, the remote computer system can: define a set of vertices representing an area of interest larger than a first convex hull bounded by positions of nodes in the set of nodes; calculate a second convex hull characterized by the set of vertices; and isolate a subset of candidate positions, in the set of candidate positions, according to the second convex hull of the set of vertices, each position in the subset of positions falling within the second convex hull, thereby enabling localization of a target device falling outside of the first convex hull.

### 6.6 Position Estimation

In another implementation, in Block S170, the remote computer system calculates an estimated position, in the reference coordinate system, occupied by the target device based on a combination of the subset of candidate positions.

For example, the remote computer system can calculate the estimated position of the target device corresponding to a centroid (or average) of positions in the subset of candidate positions.

In this implementation, the remote computer system serves (or returns) the estimated position of the target device responsive to the request, such as to the client system.

### 7. Combinatorial Choice of Antenna Elements+Clustering

In one variation, the remote computer system executes the foregoing methods and techniques: to receive a set of messages—from the set of nodes—representing time-of-arrival estimates of a signal transmitted from a target device and received at antenna elements of the set of nodes in Block S110; and to define a set of combinations of antenna elements in Block S120. Each combination of antenna elements includes an antenna element of each node in the set of nodes.

For each combination of antenna elements in the set of combinations of antenna elements, the remote computer system executes the foregoing methods and techniques: to access a group of time-of-arrival estimates of the signal and corresponding to antenna elements in the combination of antenna elements in Block S122; and to calculate a candidate position, in a set of candidate positions in the reference coordinate system, occupied by the target device based on the group of time-of-arrival estimates in Block S150.

In this variation, in Block S160, the remote computer system groups candidate positions, in the set of candidate positions, into a set of candidate groups based on proximity of candidate positions in the set of candidate positions.

For example, the remote computer system can implement structured data analysis techniques (e.g., linear regression, cluster analysis, k-means clustering, other statistical and machine learning techniques) to group candidate positions, in the set of candidate positions, into the set of position groups.

Additionally or alternatively, the remote computer system can group candidate positions, in the set of candidate positions, into the set of position groups based on scores (e.g., silhouette scores)—representing clustering quality-assigned to (or associated with) the set of position groups.

In this variation, the remote computer system: calculates a quantity of candidate positions in each position group in the set of positions groups in Block S162; and selects a target position group, in the set of position groups, characterized by a greatest quantity of candidate positions among the set of position groups in Block S164.

Additionally or alternatively, the remote computer system can: calculate a confidence value (or score) for each position group in the set of positions groups; and select the target position group characterized by a greatest confidence value among the set of position groups.

For example, the remote computer system can calculate the confidence value: proportional to the quantity of candidate positions in a position group; proportional to proximity (or inversely proportional to spread) of candidate positions in the position group; and/or proportional to proximity of candidate positions in the position group to a preceding (e.g., a most recent) estimated position, in the reference coordinate system, occupied by the target device.

The remote computer system then executes the foregoing methods and techniques to calculate an estimated position, in the reference coordinate system, occupied by the target device based on a combination of candidate positions in the target position group in Block S170.

In one example, in response to selecting the target position group, the remote computer system: calculates a centroid (or center) of candidate positions in the target position group; and calculates the estimated position of the target device based on (e.g., corresponding to) the centroid of candidate positions in the target position group.

In another example, in response to selecting the target position group, the remote computer system: calculates an average of candidate positions in the target position group; and calculates the estimated position of the target device based on (e.g., corresponding to) the average of candidate positions in the target position group.

Therefore, rather than calculating the estimated position based on an average of all candidate positions in the set of candidate positions, the remote computer system can: detect clusters of candidate positions in the set of candidate positions, such as when multiple antenna elements in a node detect different channel impulse responses that yield different time-of-arrival estimates for the node; select a target cluster including the greatest quantity of candidate positions (and/or characterized by the greatest confidence value); and calculate the estimated position occupied by the target device based on candidate positions in the target cluster.

### 7.1 Multiple Candidate Positions

In another variation, in response to grouping candidate positions in the set of candidate positions into a set of position groups, the remote computer system executes the foregoing methods and techniques to calculate a confidence value of each position group in the set of position groups.

In this variation, the remote computer system executes similar methods and techniques described above to select a subset of position groups (e.g., a set of target position groups) in the set of position groups, such as based on quantities of candidate positions and/or confidence values of the set of target position groups.

For each position group in the subset of position groups, the remote computer system executes the foregoing methods and techniques: to calculate a candidate estimated position—in a set of candidate estimated positions in the reference coordinate system-occupied by the target device based on candidate positions in the position group; and to calculating a confidence value, in a set of confidence values, of the candidate estimated position.

In this variation, the remote computer system serves the set of candidate estimated positions and the set of confidence values to a filter (e.g., a Kalman filter) for calculation of a succeeding estimated position occupied by the target device.

Accordingly, the system can: calculate multiple candidate estimated positions for the target device at a target time (or time interval); calculate confidence values of the candidate estimated positions based on spatial characteristics of candidate positions from which the candidate estimated positions are derived; and reconcile the candidate estimated positions over time in order to converge on a stable position estimate of the target device over time.

### 8. Disclaimers

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a first set of propagation delay values associated with a signal transmitted from a target device and received at a first node in a set of nodes, each propagation delay value, in the first set of propagation delay values, corresponding to an antenna element in a first set of antenna elements of the first node;
accessing a second set of propagation delay values associated with the signal received at a second node in the set of nodes, each propagation delay value, in the second set of propagation delay values, corresponding to an antenna element in a second set of antenna elements of the second node;
defining a set of combinations of antenna elements, each combination of antenna elements including an antenna element of each node in the set of nodes;
for each combination of antenna elements in the set of combinations of antenna elements:
accessing a group of propagation delay values associated with the signal and corresponding to antenna elements in the combination of antenna elements; and
calculating a candidate position, in a set of candidate positions in a reference coordinate system, occupied by the target device based on the group of propagation delay values;
isolating a subset of candidate positions, in the set of candidate positions, falling within a selected region in the reference coordinate system; and
calculating an estimated position, in the reference coordinate system, occupied by the target device based on a combination of the subset of candidate positions.

2. The method of claim 1:
wherein accessing the first set of propagation delay values comprises accessing the first set of propagation delay values comprising a first propagation delay value corresponding to a first antenna element in the first set of antenna elements;
wherein accessing the second set of propagation delay values comprises accessing the second set of propagation delay values comprising:
a second propagation delay value corresponding to a second antenna element in the second set of antenna elements; and
a third propagation delay value corresponding to a third antenna element in the second set of antenna elements; and
wherein defining the set of combinations of antenna elements comprises defining the set of combinations of antenna elements comprising:
a first combination of antenna elements:
comprising the first antenna element and the second antenna element; and
excluding the third antenna elements; and
a second combination of antenna elements:
comprising the first antenna element and the third antenna element; and
excluding the second antenna element.

3. The method of claim 2:
wherein calculating the candidate position for each combination of antenna elements comprises:
for the first combination of antenna elements, calculating a first candidate position in the set of candidate positions based on a first group of propagation delay values comprising the first propagation delay value and the second propagation delay value; and
for the second combination of antenna elements, calculating a second candidate position in the set of candidate positions based on a second group of propagation delay values comprising the first propagation delay value and the third propagation delay value; and
wherein isolating the subset of candidate positions comprises isolating the subset of candidate positions:
comprising the first candidate position; and
excluding the second candidate position.

4. The method of claim 1:
further comprising, at the first node:
receiving the signal at the first set of antenna elements;
calculating a first time-of-arrival estimate, in a first set of time-of-arrival estimates, of the signal received at a first antenna element in the first set of antenna elements;
generating a first message comprising the first set of time-of-arrival estimates associated with the first set of antenna elements; and
transmitting the first message to a remote computer system; and
wherein accessing the first set of propagation delay values comprises, at the remote computer system:
receiving the first message comprising the first set of time-of-arrival estimates; and
deriving the first set of propagation delay values based on the first set of time-of-arrival estimates.

5. The method of claim 4, wherein generating the first message comprising the first set of time-of-arrival estimates associated with the first set of antenna elements comprises encoding a first antenna element identifier of the first antenna element in a synchronization signal block index field of a first measured result item in the first message.

6. The method of claim 1, wherein accessing the first set of propagation delay values comprises:
accessing a first message from the first node, the first message comprising the first set of propagation delay values arranged in a first sequence comprising:
a first propagation delay value arranged in a first position in the first sequence; and
a second propagation delay value arranged in a second position in the first sequence; and
associating the first propagation delay value with a first antenna element in the first set of antenna elements based on the first position occupied by the first propagation delay value.

7. The method of claim 1, wherein isolating the subset of candidate positions comprises:
calculating a convex hull bounded by positions, in the reference coordinate system, occupied by nodes in the set of nodes; and
isolating the subset of candidate positions falling within the selected region comprising the convex hull.

8. The method of claim 1, wherein isolating the subset of candidate positions comprises:
accessing a set of vertices, in the reference coordinate system, representing an area of interest;
calculating a convex hull bounded by the set of vertices; and
isolating the subset of candidate positions falling within the selected region comprising the convex hull.

9. The method of claim 1, wherein isolating the subset of candidate positions comprises:
grouping candidate positions, in the set of positions, into a set of candidate groups based on proximity of candidate positions in the set of candidate positions;
for each position group in the set of positions groups, calculating a quantity of candidate positions in the position group;
selecting a target position group, in the set of position groups, characterized by a greatest quantity of candidate positions among the set of position groups; and
isolating the subset of candidate positions falling within the selected region represented by candidate positions in the target position group.

10. The method of claim 9, wherein isolating the subset of candidate positions comprises:
for each position group in the set of position groups, calculating a confidence value of the position group based on:
the quantity of candidate positions in the position group; and
proximity of positions in the position group to a preceding estimated position occupied by the target device; and
selecting the target position group characterized by a greatest confidence value among the set of position groups.

11. The method of claim 1:
wherein accessing the group of propagation delay values for each combination of antenna elements comprises, for a first combination of antenna elements in the set of combinations of antenna elements, accessing a first subset of propagation delay values, in the first set of propagation delay values, corresponding to a first antenna element in the first combination of antenna elements; and
wherein calculating the candidate position for each combination of antenna elements comprises, for the first combination of antenna elements:
generating a first probability map, in a set of probability maps, representing a first set of conditional probability masses for a set of positions in the reference coordinate system, each conditional probability mass in the first set of conditional probability masses representing a probability mass for the target device occupying a position in the set of positions based on the first subset of propagation delay values;
generating a composite probability map:
based on the set of probability maps; and
representing a third set of conditional probability masses for the set of positions based on a combination of the first set of conditional probability masses and conditional probability masses of probability maps in the set of probability maps; and
calculating a first candidate position, in the set of candidate positions, occupied by the target device based on the composite probability map, the first candidate position characterized by a greatest probability mass in the third set of conditional probability masses.

12. The method of claim 11:
wherein accessing the group of propagation delay values for each combination of antenna elements comprises, for the first combination of antenna elements, accessing a second subset of propagation delay values, in the second set of propagation delay values, corresponding to a second antenna element in the first combination of antenna elements; and
wherein calculating the candidate position for each combination of antenna elements comprises, for the first combination of antenna elements:
generating a second probability map, in the set of probability maps, representing a second set of conditional probability masses for the set of positions, each conditional probability mass in the second set of conditional probability masses representing a probability mass for the target device occupying a position in the set of positions based on the second subset of propagation delay values; and
generating the composite probability map representing the third set of conditional probability masses for the set of positions based on a product of the first set of conditional probability masses and the second set of conditional probability masses.

13. The method of claim 1:
wherein accessing the first set of propagation delay values comprises:
accessing a first set of time-of-arrival estimates of the signal received at the first node, each time-of-arrival estimate, in the first set of time-of-arrival estimates, corresponding to an antenna element in the first set of antenna elements; and
accessing a first set of quality characteristics of the signal received at the first node, the first set of quality characteristics representing:
signal-to-noise ratios of the signal received at the first set of antenna elements; and
quantities of components of the signal received at the first set of antenna elements;
wherein accessing the group of propagation delay values for each combination of antenna elements comprises, for a first combination of antenna elements in the set of combinations of antenna elements:
accessing a first time-of-arrival estimate, in the first set of time-of-arrival estimates, corresponding to a first antenna element in the first combination of antenna elements; and
accessing a first subset of quality characteristics, in the first set of quality characteristics, representing:
a first signal-to-noise ratio of the signal received at the first antenna element; and
a first quantity of components of the signal received at the first antenna element; and
wherein calculating the candidate position for each combination of antenna elements comprises, for the first combination of antenna elements, calculating a first candidate position, in the set of candidate positions, occupied by the target device based on:
the first time-of-arrival estimate;
the first signal-to-noise ratio; and
the first quantity of components.

14. The method of claim 13, wherein calculating the candidate position for each combination of antenna elements comprises, for the first combination of antenna elements:
calculating a first weight for the first antenna element based on the first signal-to-noise ratio and the first quantity of components;
access a reference time-of-arrival estimate of the signal received at a reference antenna in the first combination of antennas;
calculates a first recorded time-difference-of-arrival estimate based on the first time-of-arrival estimate and the reference time-of-arrival estimate;
characterizing a first predicted time-difference-of-arrival estimate based on:
a reference position, in the reference coordinate system, occupied by the reference antenna; and
a first position, in the reference coordinate system, occupied by the first antenna element;
characterizing a first time-difference-of-arrival error based on a difference between the first recorded time-difference-of-arrival estimate and the first predicted time-difference-of-arrival estimate;
characterizing a first weighted error metric, in a set of weighted error metrics for the first combination of antenna elements, based on an absolute value of the first time-difference-of-arrival error and the first weight; and
calculating the first candidate position that yields a minimum-value sum of the set of weighted error metrics for a set of positions in the reference coordinate system.

15. The method of claim 1, wherein calculating the estimated position comprises calculating the estimated position corresponding to a centroid of candidate positions in the subset of candidate positions.

16. A method comprising:
at each node in a set of nodes:
receiving a signal, transmitted from a target device, at a set of antenna elements of the node;
calculating a set of time-of-arrival estimates of the signal received at the set of antenna elements;
generating a message, in a set of messages indicating time-of-arrival estimates of the signal received at nodes in the set of nodes, comprising the set of time-of-arrival estimates; and
transmitting the message to a remote computer system; and
at the remote computer system:
accessing the set of messages from the set of nodes;
defining a set of combinations of antenna elements, each combination of antenna elements including an antenna element of each node in the set of nodes;
for each combination of antenna elements in the set of combinations of antenna elements:
accessing a group of time-of-arrival estimates of the signal and corresponding to antenna elements in the combination of antenna elements; and
calculating a candidate position, in a set of candidate positions in a reference coordinate system, occupied by the target device based on the group of time-of-arrival estimates;
isolating a subset of candidate positions, in the set of candidate positions, falling within a convex hull bounded by positions, in the reference coordinate system, occupied by nodes in the set of nodes; and
calculating an estimated position, in the reference coordinate system, occupied by the target device based on a centroid of candidate positions in the subset of candidate positions.

17. The method of claim 16:
wherein generating the message at each node comprises, for each antenna element in in the set of antenna elements of the node, generating the message comprising:
a time-of-arrival estimate, in the set of time-of-arrival estimates, received at the antenna element;
a signal-to-noise ratio of the signal received at the antenna element; and
a quantity of components of the signal received at the antenna element; and
wherein calculating the candidate position for each combination of antenna elements comprises:
calculating a set of weights for the combination of antenna elements based on:
a group of signal-to-noise ratios of the signal and corresponding to antenna elements in the combination of antenna elements; and
a group of quantities of components of the signal received at antenna elements in the combination of antenna elements;
calculating a set of recorded time-difference-of-arrival estimates based on the group of time-of-arrival estimates;
characterizing a set of predicted time-difference-of-arrival estimates based on positions, in the reference coordinate system, occupied by the combination of antenna elements;
characterizing a set of time-difference-of-arrival errors based on the set of recorded time-difference-of-arrival estimates and the set of predicted time-difference-of-arrival estimates; and
calculating the candidate position based on:
the set of weights; and
the set of time-difference-of-arrival errors.

18. The method of claim 16:
wherein generating the message at each node comprises generating the message comprising the set of time-of-arrival estimates arranged in a sequence according to indices of the set of antenna elements of the node; and
wherein accessing the set of messages comprises associating time-of-arrival estimates with identities of antenna elements based on positions, within messages in the set of messages, occupied by the time-of-arrival estimates.

19. A method comprising:
for each node in a set of nodes, accessing a set of time-of-arrival estimates of a signal transmitted from a target device and received at the node, each time-of-arrival estimate, in the set of time-of-arrival estimates, corresponding to an antenna element in a set of antenna elements of the node;
defining a set of combinations of antenna elements, each combination of antenna elements including an antenna element of each node in the set of nodes;
for each combination of antenna elements in the set of combinations of antenna elements:
accessing a group of time-of-arrival estimates of the signal and corresponding to antenna elements in the combination of antenna elements; and
calculating a candidate position, in a set of candidate positions in a reference coordinate system, occupied by the target device based on the group of time-of-arrival estimates;
grouping candidate positions, in the set of candidate positions, into a set of candidate groups based on proximity of candidate positions in the set of candidate positions;
for each position group in the set of position groups, calculating a quantity of candidate positions in the position group;
selecting a target position group, in the set of position groups, characterized by a greatest quantity of candidate positions among the set of position groups; and
calculating an estimated position, in the reference coordinate system, occupied by the target device based on a centroid of candidate positions in the target position group.

20. The method of claim 19:
wherein selecting the target position group comprises selecting a subset of position groups, in the set of position groups, comprising the target position group; and
wherein calculating the estimated position comprises:
for each position group in the subset of position groups:
calculating a candidate estimated position, in a set of candidate estimated positions in the reference coordinate system, occupied by the target device based on candidate positions in the position group; and
calculating a confidence value, in a set of confidence values, of the candidate estimated position; and
serving the set of candidate estimated positions and the set of confidence values to a filter for calculation of a succeeding estimated position occupied by the target device.
